(19) United States
(12) Patent Application Publication
(10) Pub. No.: US 2016/0242366 A1
(43) Pub. Date: Aug. 25, 2016

(54) Coco Fiber Planter

(71) Applicant: SUN HILL INDUSTRIES, INC., Fairfield, CT (US)

(72) Inventor: Joseph E. Cute, Geneva, IL (US)

(21) Appl. No.: 14/631,472

(22) Filed: Feb. 25, 2015

(51) Int. Cl. A01G 9/02

(52) U.S. Cl. CPC A01G 9/02; A01G 9/021

(57) ABSTRACT

A coco fiber planter is described. The planter includes a coco fiber liner having a barrier liner integrated at the base of the coco fiber liner and a rigid outer shell having a plurality of openings. The planter minimizes or prevents water leakage from the planter while also minimizing or preventing the degradation or deformation of the coco fiber liner that often occurs after coco fiber liners are exposed to water. In addition, the planter can prevent or hide the discoloration of the coco fiber liner that can also occur when coco fiber material is exposed to water.

### BACKGROUND OF THE INVENTION

Planters made from coconut fibers, i.e., coco fiber planters, provide a desirable environment for plants as a result of the coco fiber's ability to retain moisture, thereby keeping plants properly irrigated for relatively long periods and reducing the need for watering. Currently available coco planters typically use a wire frame to hold the coco liner in place and maintain the shape of the liner (see, e.g., U.S. Pat. No. 7,621,075, issued on Nov. 24, 2009). However, coco liners tend to soften over time as the fibers are exposed to water, often resulting in the liner deforming and pushing through the wire frame, or causing the fibers to break down or separate, allowing water and soil to escape the planter. Further, the exposure to water can cause dark spots or other discoloration of the coco fibers as a result of minerals in the water, which can make the liner unattractive. This degradation, deformation, and/or discoloration of the coco fiber liner can make currently available coco fiber planters unusable or undesirable, especially for indoor plantings.

Thus, there is a need in the art for a coco fiber planter that minimizes or eliminates the effects of water exposure on the coco fibers, i.e., a planter that maintains the integrity and shape of the coco fiber liner for an extended period of time. The present invention addresses this need in the art.

### SUMMARY OF INVENTION

Described herein are planters that can be used to minimize or eliminate the effects of water exposure on coco fibers or similar types of planter materials. In one embodiment, the planter, comprises: a fibrous inner liner having an outer surface and a compartment suitable for holding a plant-growing medium, wherein said inner liner is at least partially permeable to air and water; a barrier liner covering only a portion of the outer surface of the inner liner, said barrier liner comprising a material substantially impermeable to water; and an outer shell surrounding the barrier liner and at least a portion of the outer surface of the inner liner, wherein the outer shell has a plurality of openings, at least a portion of the outer surface of the inner liner not covered by the barrier liner is accessible via the openings, and less than about 25% of the surface area of the outer surface of the inner liner is accessible to the surrounding environment. In one embodiment, the fibrous inner liner comprises coco fiber. In one embodiment, the fibrous inner liner comprises a moisture-retentive material. In one embodiment, the barrier liner comprises plastic. In one embodiment, the plastic is PVC. In one embodiment, the outer shell is substantially rigid. In one embodiment, the outer shell comprises a metal. In one such embodiment, the metal is galvanized. In one embodiment, the outer shell comprises plastic. In one embodiment, the plurality of openings include openings of at least two different sizes. In one embodiment, the plurality of openings includes openings of at least two different shapes. In one embodiment, the outer shell comprises at least two regions, and the area percentage of openings in the at least two regions is substantially different. In one embodiment, at least one of the outer shell regions has no openings. In one embodiment, the shape of the fibrous inner liner is substantially maintained after exposure to water. In one embodiment, the fibrous inner liner does not protrude through the outer shell openings after exposure to water. In one embodiment, the barrier liner substantially prevents water leakage from the planter. In one embodiment, the planter further comprises a means for hanging the planter.

In one embodiment, the planter, comprises: a barrier inner liner, said barrier inner liner comprising a material substantially impermeable to water; a fibrous middle liner surrounding the barrier inner liner, wherein said fibrous middle liner is at least partially permeable to air and water, wherein only a portion of the inner surface of the middle liner is covered by the barrier inner liner and a compartment suitable for holding a plant-growing medium is formed by the barrier inner liner and fibrous middle liner; and an outer shell surrounding at least a portion of the outer surface of the middle liner, wherein the outer shell has a plurality of openings, at least a portion of the outer surface of the middle liner is accessible via the openings, and less than about 25% of the surface area of the outer surface of the inner liner is accessible to the surrounding environment. In one embodiment, the fibrous middle liner comprises coco fiber. In one embodiment, the barrier inner liner substantially prevents water leakage from the planter.

### BRIEF DESCRIPTION OF THE DRAWINGS

The following detailed description of various embodiments of the invention will be better understood when read in conjunction with the appended drawings. It should be understood, however, that the invention is not limited to the precise arrangements and instrumentalities of the embodiments shown in the drawings.

FIG. 1 is a perspective view diagram of an embodiment of a coco fiber planter.

FIG. 2 is a cross-sectional view diagram of an embodiment of a coco fiber planter.

FIG. 3, comprising FIGS. 3A and 3B, is a set of diagrams of an embodiment of a coco fiber planter.

FIG. 4 is a photo image of another embodiment of a coco fiber planter.

### DETAILED DESCRIPTION

It is to be understood that the figures and descriptions of the present invention have been simplified to illustrate elements that are relevant for a clear understanding of the present invention, while eliminating, for the purpose of clarity, many other elements found in planters and plant containers. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### DESCRIPTION

Described herein is a coco fiber planter that minimizes or prevents water leakage from the planter while also minimizing or preventing the degradation or deformation of the coco fiber liner that can occur when the coco fiber liner is exposed to water. In addition, the planter can prevent or hide the discoloration of the coco fiber liner that can also occur when coco fiber material is exposed to water. The planter includes a coco fiber liner having a barrier liner integrated at the base of the coco fiber liner and a rigid, perforated outer shell. The barrier liner minimizes or eliminates the potential for water leakage from the planter, while the outer shell masks discoloration of the coco fiber liner and also provides structural stability to the liner. Further, the planter enables the beneficial properties of coco fiber material, such as moisture retention and air permeability, to be maintained for a significantly longer period of time than currently available planters. The planter is particularly useful as an indoor plant container.

One reason that coco fiber or any similar material is desirable for use in a planter is that the individual coco fibers can retain significant levels of moisture while a liner woven from the individual fibers will exhibit permeability to air or moisture. In other words, the bulk properties of the liner exhibit high permeability because of pores or small gaps between the individual fibers, while the fibers themselves can retain moisture for a significant period of time, which can reduce the need to water plants held within the planter. However, liners made from coco fiber typically exhibit poor structural stability, and tend to bulge or otherwise lose their shape after extensive exposure to water. The coco fiber planter described herein is designed to maintain the desired shape of the liner while also maintaining the beneficial properties typically associated with coco fiber.

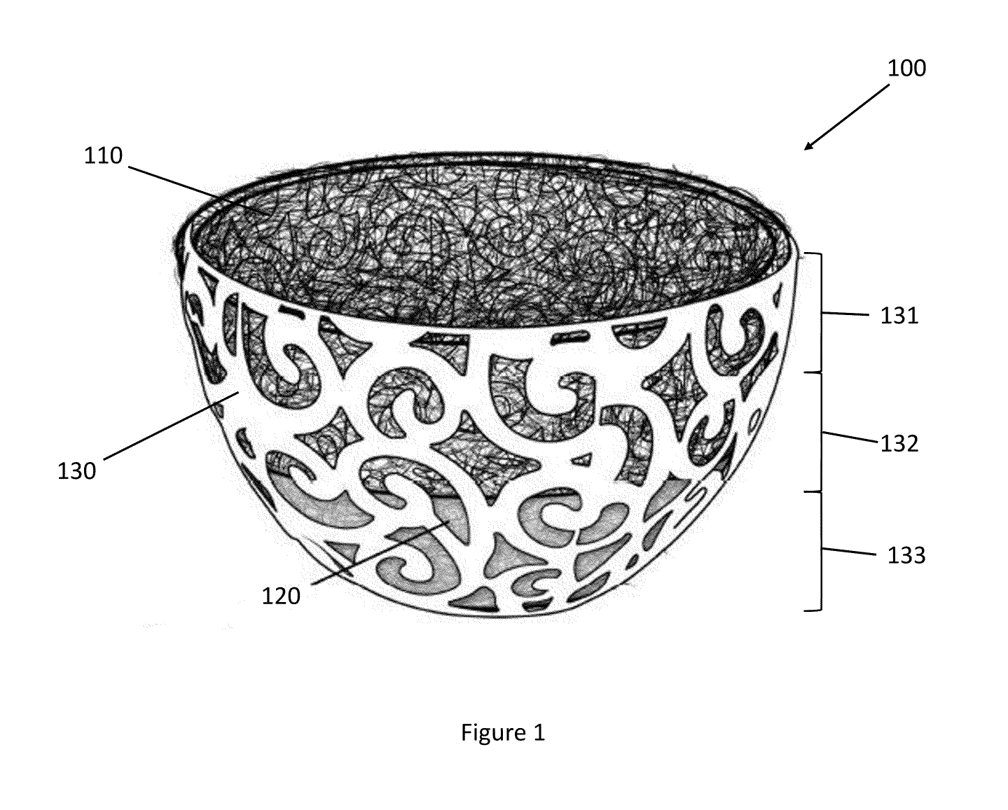

Referring now to FIG. 1, a diagram of a coco fiber planter 100 is shown. Planter 100 includes a coco fiber liner 110, a barrier liner 120 covering a portion of the outside surface of coco liner 110, and an outer shell 130 covering the outside surface of barrier liner 120 and also the portion of coco liner 110 that is not covered by barrier liner 120. A compartment is formed within the coco liner for holding soil or any other type of growing medium. In one embodiment, the shape of the compartment is primarily dictated by the shape of outer shell 130 and/or barrier liner 120. Outer shell 130 has a plurality of openings that allow for at least a portion of the outer surface of any portion of coco fiber liner 110 that is not covered by barrier liner 120 to remain exposed to the environment surrounding planter 100. Accordingly, at least a portion of coco fiber liner 110 maintains breathability, i.e., air can pass through coco fiber liner 110 to improve aeration of any soil contained within planter 100, while minimizing or preventing water leakage from the bottom of planter 100 due to the presence of barrier liner 120. In one embodiment, outer shell 130 is made of a rigid material, for example galvanized metal, which serves to maintain the shape and integrity of coco liner 110, and also to provide a structure for retaining soil and plants, as required in any type of planter or plant container. In addition, outer shell 130 includes openings to allow a significant portion of coco liner to remain uncovered, which allows coco liner 110 to breathe. In another embodiment, outer shell 130 can be made of a semi-rigid, or flexible material, such as plastic, provided that the outer shell can maintain the shape of coco liner 110 as described herein.

Outer shell 130 can have at least two regions, for example an upper region 131, a middle region 132, and a lower region 133. In one embodiment, the number, size, and/or shape of the openings in regions 131, 132, 133 can be the same, in other words, the pattern of the openings is substantially consistent over the entirety of outer shell 130. In another embodiment, the number, size, and/or shape of the openings in regions 131, 132, and 133 can be different. For example, in one embodiment, about 75% of the area of upper region 131 can be openings, about 50% of the area of middle region 132 can be openings, and about 25% of the area of lower region 133 can be openings. However, the area percentage of openings in any of regions 131, 132, 133 are not limited to any specific value described herein, and can be any value as would be understood by a person skilled in the art. In one embodiment, lower region 133 can have no openings, while the area of regions 131 and 132 can have some percentage of openings. In such an embodiment, lower region 133 can correspond approximately with the size of barrier liner 120, while regions 131 and 132 have openings sufficient for breathability of coco liner 110, as described elsewhere herein.

In other embodiments, it may be desirable to vary the amount or area percentage of openings depending on the desired amount of aeration for a given portion of planter 100. For example, for a relatively tall planter, it may be desirable to have more aeration closer to the bottom of the planter than the top, since water will typically drain to the bottom of the planter, and therefore there would be more area percentage of openings in the bottom and/or middle regions. In one embodiment, plants with shallow root systems may require relatively shallow pots or planters with more aeration, and thus more area percentage of openings in the outer shell, in the upper region of the planter. Such plants can include bonsai, mother-in-law's tongues, and most cactus species. In one embodiment, plants with deep root systems may require more aeration, and thus more area percentage of openings in the outer shell, in the middle region of the planter. Such plants can include most orchids, aloe vera, African violets, and most other common house plants. Further, orchids need more air than most plants and may require a higher area percentage of openings in the outer shell than other plants. In all cases, it is desirable to use a distinctive and pleasing arrangement of openings or perforations in the outer shell so as to provide an appealing overall look to the planter.

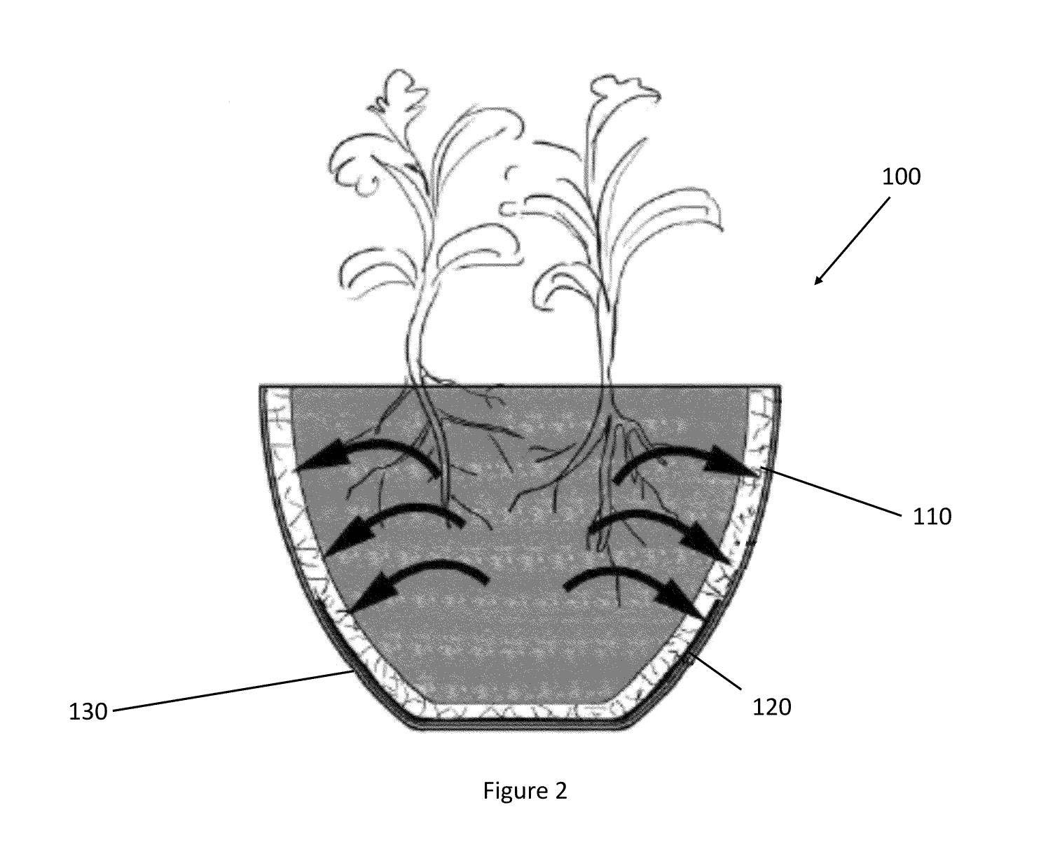

Referring now to FIG. 2, a cross-sectional view of an embodiment of planter 100 is shown. Barrier liner 120 is positioned such that the bottom of coco liner 110 and a portion of the sides of coco liner 110 are covered, which can substantially prevent water from leaking from planter 100. Accordingly, in one embodiment, barrier liner 120 is made of a material that is impermeable to moisture. In one embodiment, barrier liner 120 is made of a polymer or plastic such as poly vinyl chloride (PVC). By covering only a portion of coco liner 110 with barrier liner 120, the relatively high air permeability typically associated with coco fiber materials is maintained in the uncovered portion, which allows the plant to breathe more easily, while minimizing or preventing the water leakage typically associated with currently available coco planters. Further, the localized moisture-retentive properties typically associated with coco fiber materials are maintained at least in the portion of coco fiber liner 110 that is covered by barrier liner 120.

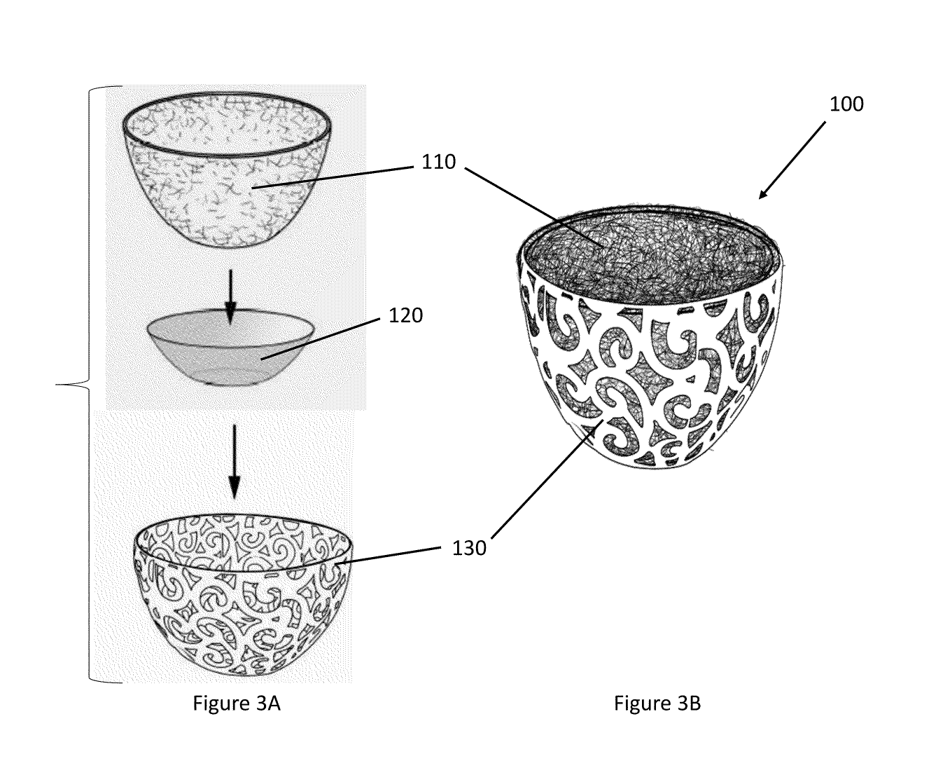

Referring now to FIG. 3, an exploded drawing of planter 100 is shown (FIG. 3A) along with a perspective view of an embodiment of planter 100 (FIG. 3B). Planter 100 includes inner coco liner 110, nested within barrier liner 120, which in turn is nested within outer shell 130. In this embodiment, outer shell 130 is a perforated metal shell that, in conjunction with barrier liner 120, covers approximately 75% of the outer surface of coco liner 110, which allows for air flow to keep plant roots healthy while maintaining the shape of coco liner 110. Further, the combination of outer shell 130 and barrier liner 120 prevents soil and water pressure from distorting coco liner 110, and also prevents soil and water from exiting coco liner 110.

In another embodiment (not shown), barrier liner 120 can be nested inside coco liner 110, which is then nested within outer shell 130. In yet another embodiment, planter 110 can include two or more coco liners. In such an embodiment, barrier liner 120 can be nested between two coco liners, and then nested within outer shell 130. As would be understood by a person skilled in the art, the nesting configurations of the components of planter 100 are not limited to the specific embodiments described herein, and the various planter components can be configured in any way such that the barrier liner imposes barrier properties on the coco liner to prevent water leakage from the planter, while allowing at least a portion of the coco liner to maintain breathability, and also such that the outer shell provides structural stability to the coco liner.

In addition, the various components can be nested together without any connecting features. However, in one embodiment, two or more components can be connected together by any suitable means as understood by a person skilled in the art. For example, the coco fiber liner and barrier liner can be connected together via glue, string, stitching, clips, or some other mechanism. Further the barrier liner and/or coco fiber liner can be affixed to the outer shell via any suitable mechanism.

Further, as would be understood by a person skilled in the art, the size and shape of coco liner 110, barrier liner 120, and outer shell 130 are not limited to any specific embodiments described herein and each of these components can be any shape or size. For example, the outer shell can be cylindrical, conical, rectangular, triangular, pyramidal, or any other shape. In addition, the size or shape of each individual component can vary with respect to the other components, For example, coco liner 110 can approximately the same size and shape as outer shell 130 or coco liner 110 can be significantly smaller or larger than outer shell 130.

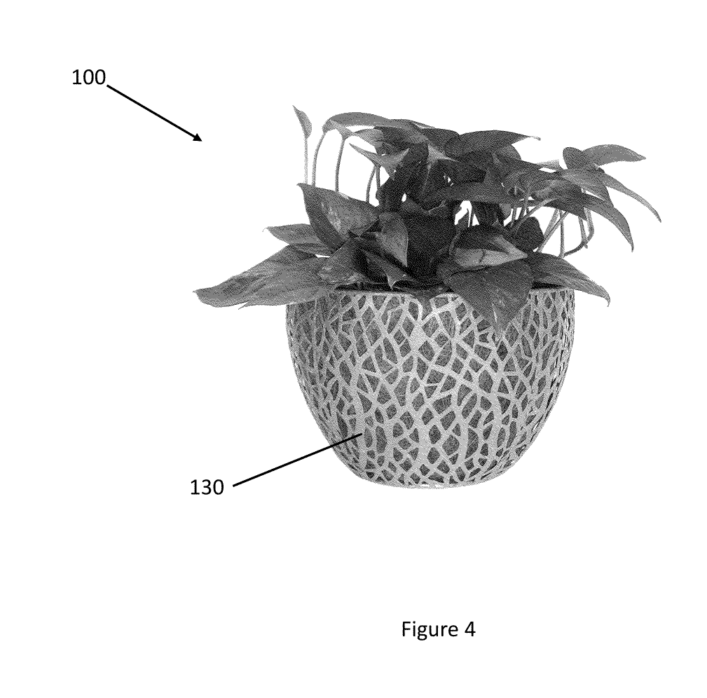

As described herein, outer shell 130 includes openings that allow uncovered portions of the coco liner to breath. In one embodiment, the openings in outer shell 130 can have a decorative or ornamental pattern as shown in FIG. 3. A different pattern for the openings in outer shell 130 is shown in FIG. 4. In one embodiment, the openings can be substantially the same size and shape. In another embodiment, the openings can have at least two different sizes and/or at least two different shapes. In one embodiment, a substantial portion of the outer shell can be solid, i.e., at least a portion of the outer shell does not have openings. However, the shape of outer shell 130 and the pattern, shape, or size of the openings in shell 130 are not limited to the specific embodiments shown or described herein, and can include any shape, size, or pattern that provides stability and structure to coco liner 110 while leaving a significant portion of the outer surface of coco liner 110 exposed to the environment surrounding planter 100.

The outer shell can also serve to mask discoloration of the coco fiber liner caused by minerals or other adulterants that are often found in water used to water the plant or that can leach from the soil or growing medium. Such minerals or adulterants can cause dark or light spots on the coco liner that are unsightly or undesirable. By masking or hiding a significant portion of the coco fiber liner, the outer shell can maintain a desirable appearance for a significantly longer period of time than currently available coco fiber planters.

In a preferred embodiment, at least 75% of the outer surface of coco liner is covered by outer shell 120 and/or barrier liner 130, i.e., about 25% or less of the outer surface is accessible to the environment surrounding the planter. In other embodiments, outer shell 120 can cover any other suitable amount of the outer surface area of coco liner 110, such as, but not limited to: 30%, 40%, 50%, 60%, 70%, 80%, or 90%.

In addition, planter 100 can include other features, as would be understood by a person skilled in the art. In one embodiment, the outer shell can include a mechanism for hanging the planter from a ceiling or pole, such as one or more loops to which a string or cord can be affixed.

Throughout this disclosure, the planter is generally described as having a coco fiber liner. However, it is contemplated herein that the coco fiber liner can be made of a material other than coconut fiber, for example, straw, peat moss, hemp cloth, jute liner, burlap, Spanish moss, or some other material that has relatively high air permeability and/or localized water retention in the individual fibers. Other materials potentially useful for the inner liner, barrier liner, or outer shell, and other components or features that can be included with the planter are described in U.S. Pat. No. 7,621,075, which is hereby incorporated by reference in its entirety.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A planter, comprising:
a fibrous inner liner having an outer surface and a compartment suitable for holding a plant-growing medium, wherein said inner liner is at least partially permeable to air and water;
a barrier liner covering only a portion of the outer surface of the inner liner, said barrier liner comprising a material substantially impermeable to water; and
an outer shell surrounding the barrier liner and at least a portion of the outer surface of the inner liner, wherein the outer shell has a plurality of openings, at least a portion of the outer surface of the inner liner not covered by the barrier liner is accessible via the openings, and less than about 25% of the surface area of the outer surface of the inner liner is accessible to the surrounding environment.

2. The planter of claim 1, wherein the fibrous inner liner comprises coco fiber.

3. The planter of claim 1, wherein the fibrous inner liner comprises a moisture-retentive material.

4. The planter of claim 1, wherein the barrier liner comprises plastic.

5. The planter of claim 4, wherein the plastic is PVC.

6. The planter of claim 1, wherein the outer shell is substantially rigid.

7. The planter of claim 1, wherein the outer shell comprises a metal.

8. The planter of claim 7, wherein the metal is galvanized.

9. The planter of claim 1, wherein the outer shell comprises plastic.

10. The planter of claim 1, wherein the plurality of openings include openings of at least two different sizes.

11. The planter of claim 1, wherein the plurality of openings includes openings of at least two different shapes.

12. The planter of claim 1, wherein the outer shell comprises at least two regions, and the area percentage of openings in the at least two regions is substantially different.

13. The planter of claim 12, wherein at least one of the outer shell regions has no openings.

14. The planter of claim 1, wherein the shape of the fibrous inner liner is substantially maintained after exposure to water.

15. The planter of claim 1, wherein the fibrous inner liner does not protrude through the outer shell openings after exposure to water.

16. The planter of claim 1, wherein the barrier liner substantially prevents water leakage from the planter.

17. The planter of claim 1, further comprising a means for hanging the planter.

18. A planter, comprising:
a barrier inner liner, said barrier inner liner comprising a material substantially impermeable to water;
a fibrous middle liner surrounding the barrier inner liner, wherein said fibrous middle liner is at least partially permeable to air and water, wherein only a portion of the inner surface of the middle liner is covered by the barrier inner liner and a compartment suitable for holding a plant-growing medium is formed by the barrier inner liner and fibrous middle liner; and
an outer shell surrounding at least a portion of the outer surface of the middle liner, wherein the outer shell has a plurality of openings, at least a portion of the outer surface of the middle liner is accessible via the openings, and less than about 25% of the surface area of the outer surface of the inner liner is accessible to the surrounding environment.

19. The planter of claim 18, wherein the fibrous middle liner comprises coco fiber.

20. The planter of claim 18, wherein the barrier inner liner substantially prevents water leakage from the planter.
